(19) United States
(12) Patent Application Publication
(10) Pub. No.: US 2011/0134236 A1
(43) Pub. Date: Jun. 9, 2011

(54) METHOD AND APPARATUS FOR STABILIZING LOCUS OF OBJECT, AND IMAGE MONITORING SYSTEM

(75) Inventors: Young-gwan JO, Changwon-city (KR); Eun-ji CHOI, Changwon-city (KR); Jeong-eun LIM, Changwon-city (KR)

(73) Assignee: SAMSUNG TECHWIN CO., LTD., Changwon-city (KR)

(21) Appl. No.: 12/858,003

(22) Filed: Aug. 17, 2010

(30) Foreign Application Priority Data
Dec. 8, 2009 (KR) 10-2009-0121112

(51) Int. Cl. H04N 9/47

(52) U.S. Cl. 348/135; 348/E09.033

(57) ABSTRACT

A method and apparatus for stabilizing a locus of an object detected from a continuously-captured image, and an image monitoring system are provided. The apparatus includes: a detection unit which detects first information about the locus provided at a first time, from the continuously-captured image; a storage unit which stores second information about the locus provided at at least one other time; a correction unit which corrects the first information based on the second information; and a display unit which applies the corrected first information to the object in the continuously-captured image to display a modified locus corresponding to the corrected first information.

### CROSS-REFERENCE TO RELATED PATENT APPLICATION

This application claims priority from Korean Patent Application No. 10-2009-0121112, filed on Dec. 8, 2009, the disclosure of which is incorporated herein in its entirety by reference.

### BACKGROUND

1. Field

Methods and apparatuses consistent with the present invention relate to locus stabilization and an image monitoring system, and more particularly, to stabilizing a locus of a dynamic object detected from a continuously-captured image and an image monitoring system.

2. Description of the Related Art

An image monitoring system includes a camera, an image storage device, and a monitor. In the image monitoring system, when the camera is installed at a place where monitoring is required, an image captured by the camera is stored in the image storage device or is displayed on the monitor. Thus, a user may analyze the image stored in the image storage device or the image displayed on the monitor, thereby monitoring a dynamic object displayed on a screen.

However, as demands for image monitoring increase, necessary manpower for analyzing the stored image or displayed image is insufficient. Thus, intelligent image monitoring systems for analyzing captured images are needed.

An intelligent image monitoring system performs various functions such as dividing a captured image into a foreground and a background and analyzing a dynamic object's behavior. Among various functions, a function of detecting and tracking the dynamic object may be a core function of the intelligent image monitoring system.

According to a related art function of detecting and tracking a dynamic object, a detection rectangle is added to a circumference of the dynamic object and is provided to the user. However, in the related art function of detecting and tracking the dynamic object, the range of errors with respect to the detection rectangle added to the dynamic object detected from a continuously-captured image is large. Thus, the detection rectangle varies in real-time and such varied detection rectangle is provided to the user, which is inconvenient for the user to view captured images.

As a result, a way to provide a detection rectangle without inconveniencing the user's viewing needs to be developed.

### SUMMARY

One or more of exemplary embodiments of the present inventive concept provides a method and apparatus for stabilizing a locus of an object detected from a continuously-captured image by which shaking of a locus generated so as to monitor the object is reduced to provide convenience to a user who monitors the object in a monitoring screen, and an image monitoring system.

According to an exemplary embodiment, there is provided an apparatus for stabilizing a locus of an object in an image, the apparatus including: a detection unit which detects from the image first information about the locus provided at a first time; a storage unit which stores second information about the locus provided at at least one other time; a predicting unit which predicts third information about the locus provided at the first time based on the second information; a correction unit which corrects the first information based on the first information and the third information; and a display unit which applies the corrected first information to the object in the image to display a modified locus corresponding to the corrected first information. The locus may take a rectangular graphic form added to a circumference of the object in the image, and each of the first, second and third information may include a dimension of the rectangular graphic form.

The predicting unit may include an X-Y predicting unit which predicts an X-Y coordinate of the locus, provided at the first time, which constitutes the first information, based on at least one X-Y coordinate of the locus, provided at the at least one other time, which constitutes the second information.

The X-Y coordinate of the locus provided at the first time is predicted based on a straight line to which a sum of squared distances from the at least one X-Y coordinate of the locus provided at the at least one other time is at a minimum.

The predicting unit may include a W-H predicting unit which predicts a height of the locus provided at the first time by averaging heights of the locus provided at the at least one other time, and predicts a width of the locus provided at the first time by averaging widths of the locus provided at the at least one other time.

The correction unit may correct the first information by applying weights to the first information and the third information.

The storage unit may store the corrected first information, and the predicting unit predicts next information about the locus provided at a next time based on the second information and the corrected first information.

If the corrected first information is stored in the storage unit, the storage unit may delete information about the locus provided at a most previous time among the second information, and the predicting unit predicts the next information based on the second information, except the deleted information, and the corrected first information.

The detection unit may detect the first information in a time interval at which an image frame which constitutes the image, which is a moving image, is generated, and the storage unit, the correction unit, and the display unit, respectively, store the second information, correct the first information, and apply the corrected first information in the time interval.

According to another exemplary embodiment, there is provided a method of stabilizing a locus of an object in an image, the method including: detecting from the image first information about the locus provided at a first time; storing second information about the locus provided at at least one other time; predicting third information about the locus provided at the first time based on the second information; correcting the first information based on the first information and the third information; and applying the corrected first information to the object in the image to display in a display unit a modified locus corresponding to the corrected first information.

The locus may take a rectangular graphic form added to a circumference of the object in the image, and each of the first, second and third information may include a dimension of the locus.

The predicting the first information may include predicting an X-Y coordinate of the locus provided at the first time which constitutes the first information, based on at least one X-Y coordinates of the locus, provided at the at least one other time, which constitutes the second information.

The X-Y coordinate of the locus provided at the first time may be predicted based on a straight line to which a sum of squared distances from the at least one X-Y coordinate of the locus provided at the at least one other time is at a minimum.

The predicting the first information may include predicting a height of the locus provided at the first time by averaging heights of the locus provided at the at least one other time, and predicts a width of the locus provided at the first time by averaging widths of the locus provided at the at least one other time.

The correcting the first information may include correcting the first information by applying weights to the first information and the third information.

The method may further include: storing the first information; and predicting next information about the locus provided at a next time based on the second information and the corrected first information.

The storing the corrected first information may include storing the corrected first information after deleting information about the locus provided at a most previous time among the second information, and the predicting the next information comprises predicting the next information based on the second information, except the deleted information, and the corrected first information.

The storing the second information may include storing the second information in a time interval at which an image frame which constitutes the image, which is a moving image, is generated, and the detecting the first information comprises detecting the first information in the time interval, and the predicting the first information comprises predicting the first information in the time interval, and the correcting the first information comprises correcting the first information in the time interval.

According to another exemplary embodiment, there is provided an image monitoring system monitoring a dynamic object included in an image, the system including: a photographing device which captures the image; a storage device which stores the captured image; and a display device which displays the captured image, wherein the photographing device or the storage device detects from the captured image first information about a locus of the dynamic object provided at a first time, predicts second information about the locus provided at the first time based on third information about the locust provided at at least one other time, corrects the first information by using the first information and the second information, and applies the corrected first information to the dynamic object in the image to display a modified locus corresponding to the corrected first information.

### BRIEF DESCRIPTION OF THE DRAWINGS

The above and other aspects of the present invention will become more apparent by describing in detail exemplary embodiments thereof with reference to the attached drawings, in which:

FIG. 1 is a block diagram showing a structure of an apparatus for stabilizing a locus of a dynamic object, according to an exemplary embodiment;

FIG. 2 illustrates a dynamic object and locus information according to an exemplary embodiment;

FIG. 3 is a block diagram showing a detailed structure of a storage unit, according to an exemplary embodiment;

FIG. 4 is a block diagram showing a detailed structure of a locus stabilization unit, according to an exemplary embodiment;

FIG. 5 illustrates current detection locus information, according to an exemplary embodiment;

FIG. 6 illustrates previous correction locus information, according to an exemplary embodiment;

FIG. 7 illustrates an operation of predicting an X-value and a Y-value, according to an exemplary embodiment;

FIG. 8 illustrates an operation of predicting a W-value and an H-value, according to an exemplary embodiment;

FIG. 9 is a flowchart illustrating a method of stabilizing a locus of a dynamic object, according to an exemplary embodiment; and

FIGS. 10A and 10B illustrate the result of locus stabilization according to an exemplary embodiment.

### DETAILED DESCRIPTION OF EXEMPLARY EMBODIMENTS

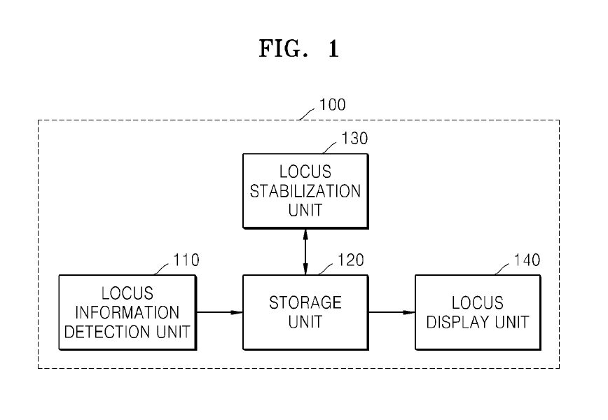

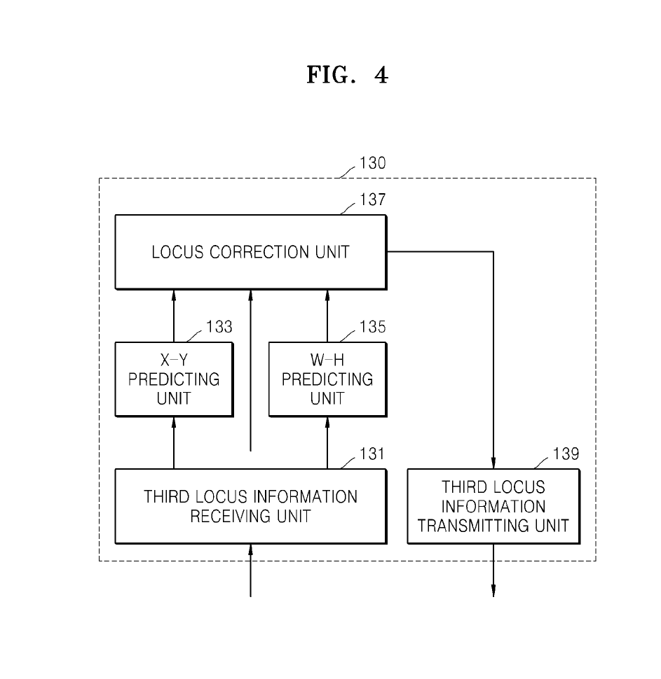

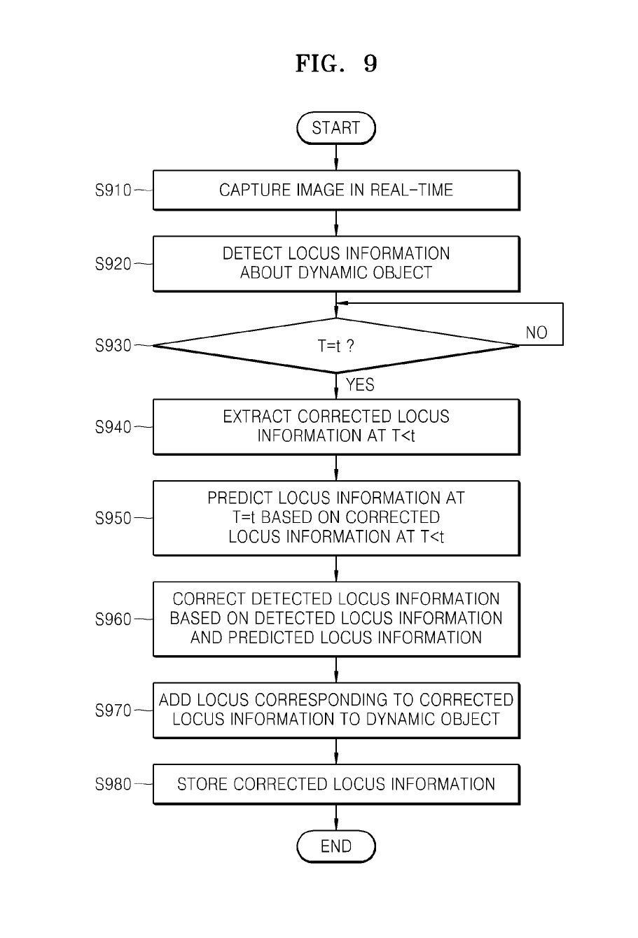

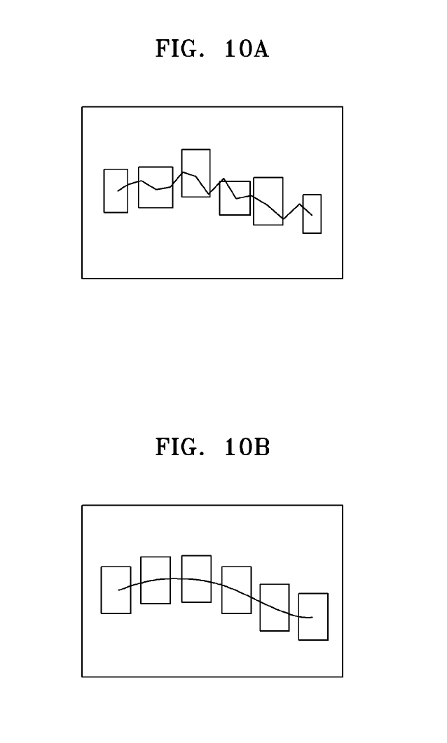

Hereinafter, the present inventive concept will be described in detail by explaining exemplary embodiments with reference to the attached drawings. In particular, a structure of an apparatus for stabilizing a locus of a dynamic object will be described with reference to FIGS. 1 through 3, a principle of stabilizing a locus of a dynamic object will be described with reference to FIGS. 4 through 8, and a method of stabilizing a locus of a dynamic object will be described with reference to FIG. 9. Also, a result of locus stabilization will be described with reference to FIGS. 10A-10B.

### <Structure of Apparatus of Stabilizing Locus of Dynamic Object>

FIG. 1 is a block diagram showing a structure of an apparatus 100 for stabilizing a locus of a dynamic object, according to an exemplary embodiment. Referring to FIG. 1, the apparatus 100 for stabilizing a locus of a dynamic object, according to the current exemplary embodiment, is installed in a camera for capturing an image including a dynamic object or an image storage device for storing the image including the dynamic object, and stabilizes a locus of the dynamic object included in the captured image or stored image.

Also, the apparatus 100 for stabilizing the locus of the dynamic object may be installed separately from the camera or image storage device to stabilize the locus of the dynamic object included in an image captured by the camera or an image stored by the image storage device.

The apparatus 100 for stabilizing a locus of a dynamic object includes a locus information detection unit 110, a storage unit 120, a locus stabilization unit 130, and a locus display unit 140.

The locus information detection unit 110 detects the dynamic object included in the captured or stored image, and detects locus information from the detected dynamic object.

The dynamic object is an object that is movable on a continuously-captured image. For example, when a building and a car are included in the continuously-captured image and the car moves, the car corresponds to the dynamic object. Contrary to this, the building is considered not to move. Thus, the building corresponds to a static object.

Also, when there is an arbitrary rectangle (hereinafter referred to as a ‘detection rectangle’) that surrounds a circumference of the dynamic object so as to indicate that the dynamic object has been detected, the locus information refers to an X-coordinate and a Y-coordinate that correspond to the center of the detection rectangle, a width W and a height H of the detection rectangle, and a time at which the X-coordinate, the Y-coordinate, the width W and the height H are obtained. For example, when the dynamic object has a central coordinate value (X, Y)=(3, 2) on a screen at time T=1, and has a width of 1 and a height of 1.5, locus information about the dynamic object is {T=1, X=3, Y=2, W=1, H=1.5}.

Thus, the locus information about the dynamic object is generated according to time. In particular, the locus information about the dynamic object may be generated in a predetermined time interval that is set by a user or in a time interval that corresponds to each frame in which the image is captured.

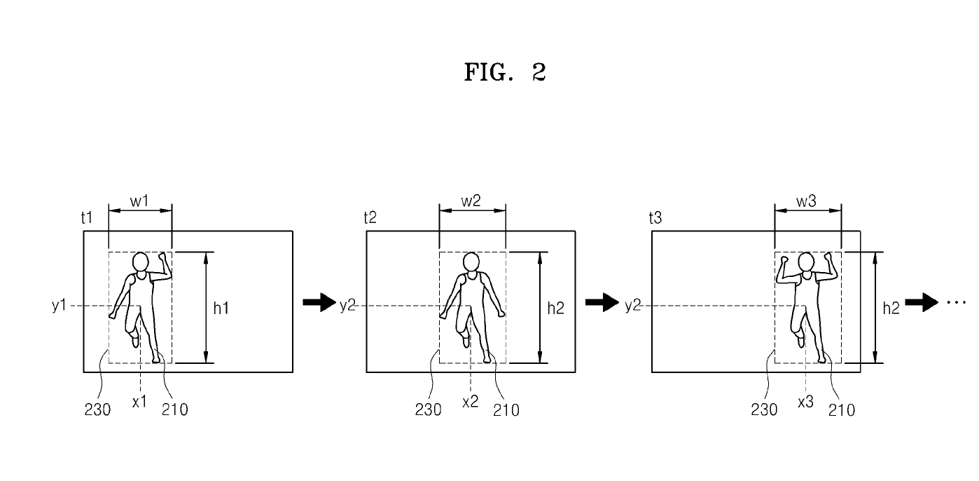

For better understanding, the dynamic object and the locus information will be described with reference to FIG. 2. FIG. 2 illustrates the dynamic object and the locus information.

Referring to FIG. 2, it is assumed that a first image is captured in one frame at a time t1, a second image is captured in the next frame at time t2, and a third image is captured in the next frame at time t3.

In this case, it can be seen that an object included in each image captured at each time of t1, t2, and t3 is moved. Thus, the object corresponds to a dynamic object 210.

Also, when a detection rectangle 230 is added to a circumference of the dynamic object 210 included in each image captured at each time of t1, t2, and t3, a time at which the detection rectangle 230 is added to the dynamic object 210, a central point coordinate value of the detection rectangle 230, and a width and a height of the detection rectangle 230 correspond to the locus information.

In FIG. 2, the locus information is {t1, x1, y1, w1, h1}, {t2, x2, y2, w2, h2}, and {t3, x3, y3, w3, h3}, and so on.

Referring back to FIG. 1, the locus information detection unit 110 detects the dynamic object, detects locus information from the detected dynamic object, and transfers the detected locus information to the storage unit 120.

The locus information detected by the locus information detection unit 110 and transferred to the storage unit 120 is locus information about the dynamic object included in an image captured at a current time (hereinafter referred to as ‘current detection locus information’). In detail, the locus information detection unit 110 monitors the dynamic object included in the captured or stored image in real-time, and transfers the locus information about the monitored dynamic object to the storage unit 120 in real-time.

The storage unit 120 stores the detection locus information received from the locus information detection unit 110. Also, the storage unit 120 stores locus information applied to the dynamic object included in an image captured at a previous time (hereinafter referred to as ‘previous correction locus information’). The previous correction locus information is used to correct the current detection locus information, as will be described later.

The locus information applied to the dynamic object has a different meaning from that of the locus information detected from the dynamic object. The detected locus information is locus information about the detection rectangle in a state where locus correction for locus stabilization is not performed, whereas the locus information applied to the dynamic object is locus information about the detection rectangle in a state where locus correction for locus stabilization is performed.

The ‘current detection locus information’ or the ‘previous correction locus information’ is classified based on a predetermined time for convenience of explanation. In detail, when locus information about the dynamic object included in an image captured at a next time (hereinafter referred to as ‘next detection locus information’) is received, the ‘current detection locus information’ cannot be regarded as the ‘current detection locus information’ any more, and the ‘next detection locus information’ cannot be regarded as the ‘next detection locus information’ any more. In the exemplary embodiments described herein, however, expressions such as the ‘previous detection locus information’, the ‘current detection locus information’, the ‘current correction locus information’, and the ‘next detection locus information’ are used based on a predetermined time for convenience of explanation.

The storage unit 120 transfers the ‘previous correction locus information’ and the ‘current detection locus information’ to the locus stabilization unit 130, and receives locus information to be applied (hereinafter referred to as ‘current correction locus information’) to the dynamic object included in an image captured at the current time from the locus stabilization unit 130.

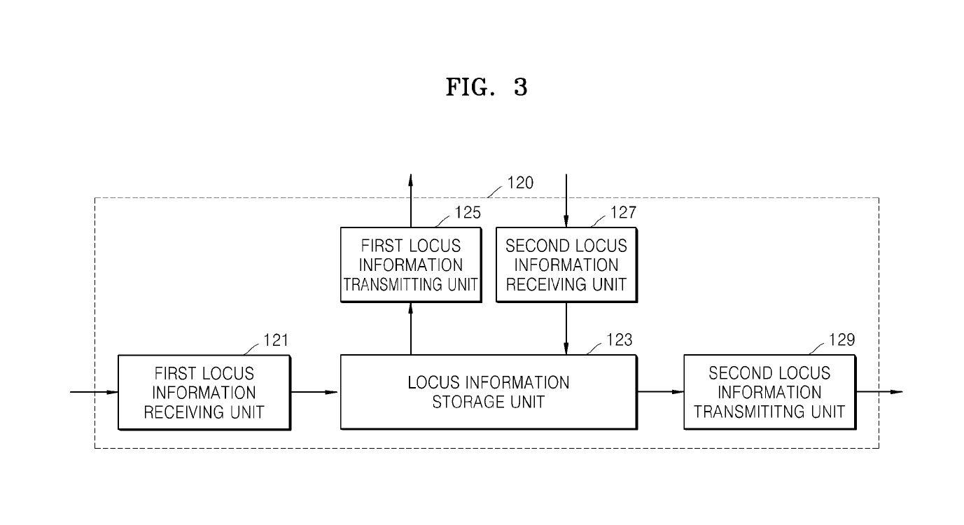

The structure of the storage unit 120 will be described in greater detail with reference to FIG. 3. FIG. 3 is a block diagram showing a detailed structure of the storage unit 120, according to an exemplary embodiment.

Referring to FIG. 3, the storage unit 120 includes a first locus information receiving unit 121, a locus information storage unit 123, a first locus information transmitting unit 125, a second locus information receiving unit 127, and a second locus information transmitting unit 129.

The first locus information receiving unit 121 receives ‘current detection locus information’ from the locus information detection unit 110 and transfers the received ‘current detection locus information’ to the locus information storage unit 123.

The locus information storage unit 123 receives the ‘current detection locus information’ from the first locus information receiving unit 121, and stores the received ‘current detection locus information’. Also, the locus information storage unit 123 transfers the ‘current detection locus information’ and pre-stored ‘previous correction locus information’ to the first locus information transmitting unit 125, and the first locus information transmitting unit 125 transfers the ‘current detection locus information’ and the ‘previous correction locus information’ to the locus stabilization unit 130 that will be described later.

When the ‘current detection locus information’ is stabilized by the locus stabilization unit 130, based on the ‘current detection locus information’ and the ‘previous correction locus information’, and is converted into the ‘current correction locus information’, the ‘current correction locus information’ is transferred to the second locus information receiving unit 127.

The second locus information receiving unit 127 receives the ‘current correction locus information’, transfers the received ‘current correction locus information’ to the locus information storage unit 123, and the locus information storage unit 123 receives the ‘current correction locus information’, and stores the received ‘current correction locus information’.

By repeatedly performing the above-described operations, the locus information storage unit 123 stores the ‘current correction locus information’ and the ‘previous correction locus information’. In detail, when the ‘next detection locus information’ is received from the locus information storage unit 123, the ‘next detection locus information’ is transferred to the locus stabilization unit 130 as the ‘current detection locus information’, and the ‘current correction locus information’ is stored in the locus information storage unit 123 as the ‘previous correction locus information’.

The locus information storage unit 123 may store from the correction locus information acquired in the first time to the correction locus information in the current frame. However, the locus information storage unit 123 may store only some of the ‘previous correction locus information’ corresponding to predetermined frames in consideration of the capacity of a memory and the number of correction locus information that is necessary for performing line fitting that will be explained later. In this case, when the ‘current correction locus information’ is received by the second locus information receiving unit 127, the locus information storage unit 123 may store the ‘current correction locus information’ after deleting the oldest correction locus information among the stored ‘previous correction locus information’.

The locus information storage unit 123 transfers the ‘current correction locus information’ to the second locus information transmitting unit 129, and the second locus information transmitting unit 129 transfers the ‘current correction locus information’ to the locus display unit 140 that will be described later.

Referring back to FIG. 1, the storage unit 120 performs the above-described operations in a time interval that corresponds to each frame in which an image is captured, or in a predetermined time interval that is set by the user, thereby storing the ‘current detection locus information’, the ‘previous correction locus information’, and the ‘current correction locus information’.

The locus stabilization unit 130 receives the ‘current detection locus information’ and the ‘previous correction locus information’ from the storage unit 120, performs an operation on the ‘current detection locus information and the ‘previous correction locus information’ to generate the ‘current correction locus information’, as described above.

The structure of the locus stabilization unit 130 will be described in greater detail with reference to FIG. 4.

FIG. 4 is a block diagram showing a detailed structure of the locus stabilization unit 130, according to an exemplary embodiment. Referring to FIG. 4, the locus stabilization unit 130 includes a third locus information receiving unit 131, an X-Y predicting unit 133, a W-H predicting unit 135, a locus correction unit 137, and a third locus information transmitting unit 139.

The third locus information receiving unit 131 receives the ‘current detection locus information’ and the ‘previous correction locus information’ from the first locus information transmitting unit 125, and transfers the received ‘current detection locus information’ and the received ‘previous correction locus information’ to the X-Y predicting unit 133, the W-H predicting unit 135, and the locus correction unit 137.

In particular, the third locus information receiving unit 131 transfers an X-coordinate and a Y-coordinate, that correspond to a central value of the detection rectangle, of the ‘previous correction locus information’, to the X-Y predicting unit 133, transfers a W-value and a H-value, that correspond to the width and the height of the detection rectangle, of the ‘previous correction locus information’, to the W-H predicting unit 135, and transfers the ‘current detection locus information’ to the locus correction unit 137.

The X-Y predicting unit 133 predicts an X-coordinate and a Y-coordinate of a predicted locus (hereinafter referred to as ‘current prediction locus information’) about the dynamic object included in an image captured at the current time based on X-Y coordinates of the ‘previous correction locus information’.

Also, the W-H predicting unit 135 predicts a W-value and an H-value of the ‘current prediction locus information’ based on W-values and H-values of the ‘previous correction locus information’.

The X-value and the Y-value of the ‘current prediction locus information’ and the W-value and the H-value of the ‘current prediction locus information’ are predicated in different ways, and a detailed operation of generating the ‘current prediction locus information’ will be described later.

The X-Y predicting unit 133 transfers the predicted X-value and Y-value to the locus correction unit 137, and the W-H predicting unit 135 transfers the predicted W-value and H-value to the locus correction unit 137.

The locus correction unit 137 receives the predicted X-value and Y-value from the X-Y predicting unit 133, receives the X-value and the Y-value of the ‘current detection locus information’ from the third locus information receiving unit 131, and determines the X-value and the Y-value of the ‘current correction locus information’ by using the received X-value and Y-value from the X-Y predicting unit 133 and the received X-value and Y-value of the ‘current detection locus information’ from the third locus information receiving unit 131.

In particular, the locus correction unit 137 gives a weight that is set by the user to the predicted X-value and Y-value and the X-value and Y-value of the ‘current detection locus information’, and determines the X-value and the Y-value of the ‘current correction locus information’.

For example, when a weight α is given to the predicted X-value and Y-value, a weight δ or 1−α may be given to the X-value and Y-value of the ‘current detection locus information’.

Also, the locus correction unit 137 receives the predicted W-value and H-value from the W-H predicting unit 135, receives the W-value and the H-value of the ‘current detection locus information’ from the third locus information receiving unit 131, and determines the W-value and the H-value of the ‘current correction locus information’ by using the received W-value and H-value from the W-H predicting unit 135 and the received W-value and the H-value of the ‘current detection locus information’.

In particular, the locus correction unit 137 gives a weight that is set by the user to the predicted W-value and H-vale and the W-value and the H-value of the ‘current detection locus information’, and determines the W-value and the H-value of the ‘current correction locus information’.

For example, when a weight y is given to the predicted W-value and H-value, a weight δ or 1−γ may be given to the W-value and H-value of the ‘current detection locus information’.

The locus correction unit 137 transfers the ‘current correction locus information’ to the third locus information transmitting unit 139, and the third locus information transmitting unit 139 transfers the ‘current correction locus information’ to the storage unit 120.

Referring back to FIG. 1, the storage unit 120 stores the ‘current correction locus information’ in the locus information storage unit 123 so that the ‘current correction locus information’ can be used to generate the ‘next correction locus information’. Also, the storage unit 120 transfers the ‘current correction locus information’ to the locus display unit 140.

The locus display unit 140 generates a detection rectangle based on the ‘current correction locus information’ and allows the generated detection rectangle to be added to the dynamic object included in the captured image.

Thus, shaking of the detection rectangle is reduced to enable better monitoring of the dynamic object, and thereby providing convenience when the user who monitors the dynamic object views a monitoring screen.

### <Principle of Locus Stabilization>

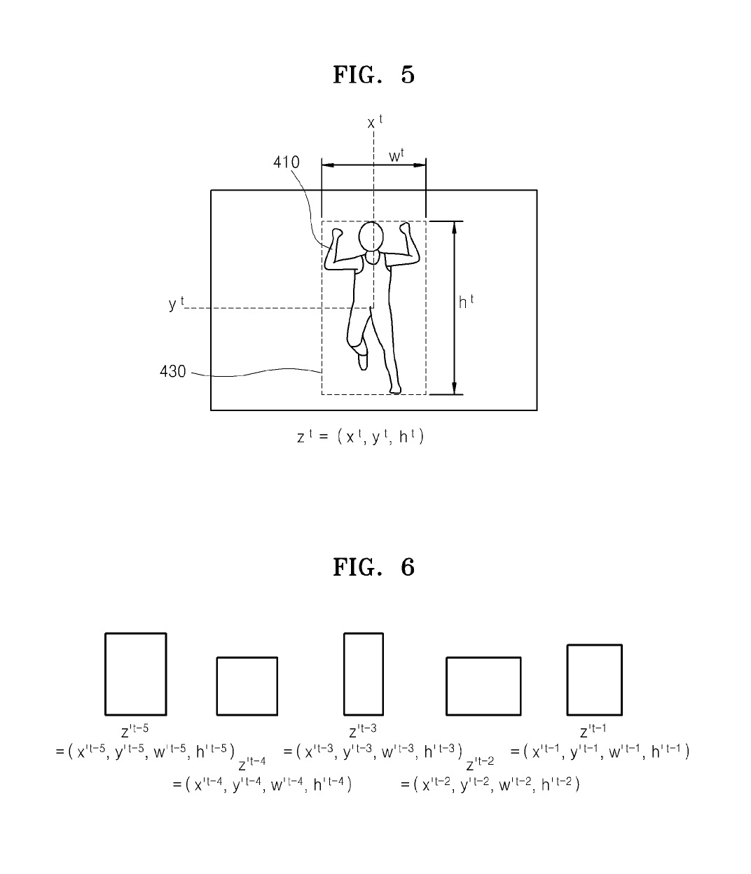

Hereinafter, an operation of predicting locus information by using the X-Y predicting unit 133 and the W-H predicting unit 135 will be described with reference to FIGS. 5 through 8.

FIG. 5 illustrates ‘current detection locus information’. Referring to FIG. 5, the apparatus 100 for stabilizing the locus of the dynamic object generates a detection rectangle based on a dynamic object 410 included in an image captured at a current time, and calculates the ‘current detection locus information’ from the detection rectangle.

For example, when the current time is t, a central coordinate value (x^{t}, y^{t}) of the detection rectangle, a width w^{t} of the detection rectangle, and a height h^{t} of the detection rectangle are the ‘current detection locus information’. For convenience of explanation, when the ‘current detection locus information’ is z^{t}, z^{t}=x^{t}, y^{t}, w^{t}, h^{t}).

FIG. 6 illustrates ‘previous correction locus information’. It has been already mentioned that the locus information storage unit 123 stores the ‘previous correction locus information’. In FIG. 6, five sets of ‘previous correction locus information’ calculated from difference detection rectangles at different times are illustrated.

In detail, it is assumed that ‘previous correction locus information’ about a time t−5, ‘previous correction locus information’ about a time t−4, ‘previous correction locus information’ about a time t−3, ‘previous correction locus information’ about a time t−2, and ‘previous correction locus information’ about a time t−1 are referred to as z′^{t-5}, z′^{t-4}, z′^{t-3}, z′^{t-2}, and z′^{t-1} as illustrated in FIG. 6.

The X-Y predicting unit 133 predicts an X-coordinate and a Y-coordinate of ‘current prediction locus information’ based on the ‘previous correction locus information’, and the W-H predicting unit 135 predicts a W-value and an H-value of the ‘current prediction locus information’ based on the ‘previous correction locus information’.

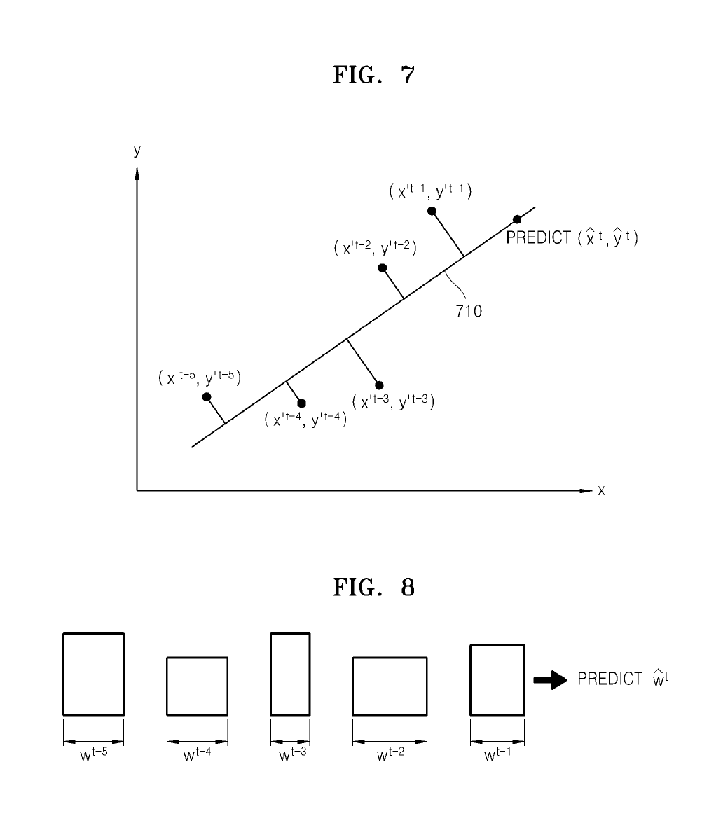

Hereinafter, an operation of predicting the X-coordinate and the Y-coordinate of the ‘current prediction locus information’ will be described with reference to FIG. 7, and an operation of predicting the W-value and the H-value of the ‘current prediction locus information’ will be described with reference to FIG. 8.

FIG. 7 illustrates an operation of predicting the X-coordinate and the Y-coordinate of the ‘current prediction locus information”.

The X-coordinate and the Y-coordinate of the ‘current prediction locus information’ are predicted by performing line fitting based on the ‘previous correction locus information’.

In line fitting, a straight line 710 to which the sum of squared distances from X-Y coordinates of the ‘previous correction locus information’, is at a minimum is obtained, and the ‘current prediction locus information’ is predicted from the straight line 710. In the example of FIG. 7, the straight line 710 in which the sum of squared distances from X-Y coordinates (x′^{t-5}, y′^{t-5}), (x′^{t-4}, y′^{t-4}), (x′^{t-3}, y′^{t-3}), (x′^{t-2}, y′^{t-2}), and (x′^{t-1}, y′^{t-1}) is at a minimum is obtained, and a prediction coordinate (\hat{x}^{t}, ŷ^{t}) is predicted from the straight line 710.

In order to calculate a vertical distance to the straight line 710 from each of X-Y coordinates of the ‘previous correction locus information’, a straight line fitting coordinate present on the straight line 710 should be calculated. The straight line fitting coordinate is a coordinate of a point in which an X-Y coordinate of the ‘previous correction locus information’ is connected to the straight line 710.

When a plurality of straight line fitting coordinates are calculated, an X-coordinate of the ‘current correction locus information’ may be calculated at a portion where the straight line fitting coordinates are connected to one another and extended, as illustrated in FIG. 7.

An operation of obtaining the Y-coordinate of the plurality of straight line fitting coordinates is the same as the operation of obtaining the X-value of the plurality of straight line fitting coordinates, as described above or may be inferred therefrom. Thus, a detailed description thereof will not be provided here.

FIG. 8 illustrates an operation of predicting a W-value and an H-value. Referring to FIG. 8, the W-value is predicted by obtaining an average of W-values of the ‘previous correction locus information’. In detail, in the example of FIG. 8, w^{t} is predicted by averaging the W-values that correspond to w^{t-5}, w^{t-4}, w^{t-3}, w^{t-2}, and w^{t-1}.

The H-value is also predicted by obtaining an average of H-values of the ‘previous correction locus information’ similar to the W-value. In detail, referring to the example of FIG. 8, h^{t} is predicted by averaging the H-values that correspond to h^{t-5}, h^{t-4}, h^{t-3}, h^{t-2} h^{t-1}.

### <Flow of Method of Stabilizing Locus of Dynamic Object>

Hereinafter, a method of stabilizing a locus of a dynamic object, according to an exemplary embodiment will be described with reference to FIG. 9. FIG. 9 is a flowchart illustrating the method of stabilizing a locus of a dynamic object, according to an exemplary embodiment.

The apparatus 100 for stabilizing the locus of the dynamic object captures an image in real-time (S910), and detects ‘current detection locus information’ that is locus information about a dynamic object included in the captured image (S920).

If a current time T is t (S930), the apparatus 100 for stabilizing the locus of the dynamic object extracts ‘previous correction locus information’ that is corrected locus information at a prior time before t (S940), and calculates ‘current prediction locus information’ that is locus information at T=t based on the ‘previous correction locus information’ (S950).

Also, the apparatus 100 for stabilizing the locus of the dynamic object corrects the ‘current detection locus information’ based on the ‘current detection locus information’ and the ‘current prediction locus information’, and generates ‘current correction locus information’ (S960). For example, a detection rectangle is generated based on the ‘current correction locus information’.

After that, the apparatus 100 for stabilizing the locus of the dynamic object adds a locus, for example, a detection rectangle, that corresponds to the ‘current correction locus information’ to the dynamic object (S970), and stores the ‘current correction locus information’ (S980).

### <Result of Locus Stabilization>

Hereinafter, a screen in a state where a locus of a dynamic object is stabilized will be descried with reference to FIGS. 10A and 10B.

When the method of stabilizing the locus of the dynamic object illustrated in FIG. 9 is not used, an error will be included in locus information, as shown on the screen of FIG. 10A, and when a detection rectangle is added to a dynamic object, there is significant shaking and hand shaking of the detection rectangle, and the size of the detection rectangle is varied in various ways.

This causes inconvenience to a user viewing a monitoring screen.

However, when the method of stabilizing the locus of the dynamic object illustrated in FIG. 9 is used, the locus information will not be included in an error, as shown on the screen of FIG. 10B, and when the detection rectangle is added to the dynamic object, there is hardly any shaking and hand shaking of the detection rectangle, and the size of the detection rectangle is nearly uniform.

Thus, convenience to the user viewing the monitoring screen so as to monitor the dynamic object can be provided.

While the present inventive concept has been particularly shown and described with reference to the exemplary embodiments thereof, it will be understood by those of ordinary skill in the art that various changes in form and details may be made therein without departing from the spirit and scope of the present inventive concept as defined by the following claims.

What is claimed is:

1. An apparatus for stabilizing a locus of an object in an image, the apparatus comprising:
a detection unit which detects from the image first information about the locus provided at a first time;
a storage unit which stores second information about the locus provided at at least one other time;
a correction unit which corrects the first information based on the second information; and
a display unit which applies the corrected first information to the object in the image to display a modified locus corresponding to the corrected first information.

2. The apparatus of claim 1, wherein the locus is displayed in the display unit to indicate that the object is detected by a monitoring device,
wherein the locus is displayed around the object, and
wherein the object is a dynamic object which moves in the image.

3. The apparatus of claim 1 further comprising a predicting unit which predicts third information about the locus provided at the first time based on the second information,
wherein the correction unit corrects the first information based on the first information and the third information.

4. The apparatus of claim 3, wherein the locus is an outline added to a circumference of the object in the image, and each of the first information, the second information and the third information comprises a dimension of the outline.

5. The apparatus of claim 3, wherein the outline comprises a polygon, and the dimension comprises at least one of an X-Y coordinate of a center, a height and a width of the polygon.

6. The apparatus of claim 3, wherein the predicting unit comprises an X-Y predicting unit which predicts an X-Y coordinate of the locus, provided at the first time, which constitutes the first information, based on at least one X-Y coordinate of the locus, provided at the at least one other time, which constitutes the second information.

7. The apparatus of claim 6, wherein the X-Y coordinate of the locus provided at the first time is predicted based on a straight line to which a sum of squared distances from the at least one X-Y coordinate of the locus provided at the at least one other time is at a minimum.

8. The apparatus of claim 6, wherein the predicting unit further comprises a W-H predicting unit which predicts a height of the locus provided at the first time by averaging heights of the locus provided at the at least one other time, and predicts a width of the locus provided at the first time by averaging widths of the locus provided at the at least one other time.

9. The apparatus of claim 3, wherein the locus information predicting unit comprises a W-H predicting unit which predicts a height of the locus provided at the first time by averaging heights of the locus provided at the at least one other time, and predicts a width of the locus provided at the first time by averaging widths of the locus provided at the at least one other time.

10. The apparatus of claim 3, wherein the correction unit corrects the first information by applying weights to the first information and the third information.

11. The apparatus of claim 3, wherein the storage unit stores the corrected first information, and the predicting unit predicts next information about the locus provided at a next time based on the second information and the corrected first information.

12. The apparatus of claim 11, wherein, if the corrected first information is stored in the storage unit, the storage unit deletes information about the locus provided at a most previous time among the second information, and the predicting unit predicts the next information based on the second information, except the deleted information, and the corrected first information.

13. The apparatus of claim 1, wherein the detection unit detects the first information in a time interval at which an image frame which constitutes the image, which is a moving image, is generated, and the storage unit, the correction unit, and the display unit, respectively, store the second information, correct the first information, and apply the corrected first information in the time interval.

14. A method of stabilizing a locus of an object in an image, the method comprising:
detecting from the image first information about the locus provided at a first time;
storing second information about the locus provided at at least one other time;
correcting the first information based on the second information; and
applying the corrected first information to the object in the image to display in a display unit a modified locus corresponding to the corrected first information.

15. The method of claim 13, wherein the locus is displayed in the display unit to indicate that the object is detected by a monitoring device,
wherein the locus is displayed around the object, and
wherein the object is a dynamic object which image changes.

16. The method of claim 14 further comprising:
predicting third information about the locus provided at the first time based on the second information;
wherein the correcting the first information comprises correcting the first information based on the first information and the third information.

17. The method of claim 16, wherein the locus is an outline added to a circumference of the object in the image, and each of the first information, the second information and the third information comprises a dimension of the outline.

18. The method of claim 16, wherein the outline comprises a polygon, and the dimension comprises at least one of an X-Y coordinate of a center, a height and a width of the polygon.

19. The method of claim 16, wherein the predicting the first information comprises predicting an X-Y coordinate of the locus provided at the first time which constitutes the first information, based on at least one X-Y coordinates of the locus, provided at the at least one other time, which constitutes the second information.

20. The method of claim 19, wherein the X-Y coordinate of the locus provided at the first time is predicted based on a straight line to which a sum of squared distances from the at least one X-Y coordinate of the locus provided at the at least one other time is at a minimum.

21. The method of claim 19, wherein the predicting the first information further comprises predicting a height of the locus provided at the first time by averaging heights of the locus provided at the at least one other time, and predicts a width of the locus provided at the first time by averaging widths of the locus provided at the at least one other time.

22. The method of claim 16, wherein the predicting the first information further comprises predicting a height of the locus provided at the first time by averaging heights of the locus provided at the at least one other time, and predicts a width of the locus provided at the first time by averaging widths of the locus provided at the at least one other time.

23. The method of claim 16, wherein the correcting the first information comprises correcting the first information by applying weights to the first information and the third information.

24. The method of claim 16, further comprising:
storing the corrected first information; and
predicting next information about the locus provided at a next time based on the second information and the corrected first information.

25. The method of claim 24, wherein the storing the corrected first information comprises storing the corrected first information after deleting information about the locus provided at a most previous time among the second information, and the predicting the next information comprises predicting the next information based on the second information, except the deleted information, and the corrected first information.

26. The method of claim 14, wherein the storing the second information comprises storing the second information in a time interval at which an image frame which constitutes the image, which is a moving image, is generated, and the detecting the first information comprises detecting the first information in the time interval, and the predicting the first information comprises predicting the first information in the time interval, and the correcting the first information comprises correcting the first information in the time interval.

27. An image monitoring system monitoring a dynamic object included in an image, the system comprising:
a photographing device which captures the image;
a storage device which stores the captured image; and
a display device which displays the captured image,
wherein the photographing device or the storage device detects from the captured image first information about a locus of the dynamic object provided at a first time, predicts second information about the locus provided at the first time based on third information about the locus provided at at least one other time, corrects the first information by using the first information and the second information, and applies the corrected first information to the dynamic object in the image to display a modified locus corresponding to the corrected first information.
